(19) United States
(12) Patent Application Publication
(10) Pub. No.: US 2026/0129536 A1
(43) Pub. Date: May 7, 2026

(54) TERMINAL, BASE STATION AND COMMUNICATION METHOD

(71) Applicant: NTT DOCOMO, INC., Tokyo (JP)

(72) Inventor: Tianyang Min, Chiyoda-ku, Tokyo (JP)

(73) Assignee: NTT DOCOMO, INC., Tokyo (JP)

(21) Appl. No.: 19/117,517

(22) PCT Filed: Aug. 24, 2023
(86) PCT No.: PCT/JP2023/030476

§ 371 Date: Apr. 1, 2025

(30) Foreign Application Priority Data
Oct. 14, 2022 (JP) 2022-165611

(51) Int. Cl. H04W 36/16

(52) U.S. Cl. CPC H04W 36/165

(57) ABSTRACT

A terminal includes: a receiving unit configured to receive system information via downlink; and a control unit configured to assume that information that indicates whether or not a serving cell is a cell supporting a base station energy saving function is included in the system information.

### FIELD OF THE INVENTION

The present invention relates to a terminal, a base station, and a communication method in wireless communication system.

### BACKGROUND OF THE INVENTION

The requirements of “New Radio” (NR) (also referred to as “5G”), which is a successor system of long-term evolution (LTE), include large system capacity, high data transmission speed, low latency, simultaneous access from multiple terminals, low cost, power saving, and so forth, and a variety of technologies are under study to meet these requirements (see, for example, non-patent document 1).

NR Release 18 discusses specifics about how to save base stations'energy. More details are planned to be discussed in the future.

### RELATED-ART DOCUMENTS

### Non-Patent Documents

Non-Patent Document 1: 3GPP TS 38.300 V16.8.0 (2021-12)

### SUMMARY OF THE INVENTION

### Technical Problem

One heretofore unaddressed issue is that there are no rules about how to transmit and receive information about base station energy saving functions.

The present invention has been made in view of the above and therefore aims to enable transmission and reception of information about base station energy saving functions.

### Solution to Problem

According to the present disclosure, a terminal is provided. This terminal includes: a receiving unit configured to receive system information via downlink; and a control unit configured to assume that information that indicates whether or not a serving cell is a cell supporting a base station energy saving function is included in the system information.

### Advantageous Effects of Invention

The present disclosure provides a technique for enabling transmission and reception of information about base station energy saving functions.

### BRIEF DESCRIPTION OF THE DRAWINGS

FIG. 1 is a diagram for explaining a wireless communication system according to an embodiment of the present invention;

FIG. 2 is a sequence diagram showing an example communication flow according to a fourth embodiment of the present invention;

FIG. 3 is a first sequence diagram showing an example communication flow according to a fifth embodiment of the present invention;

FIG. 4 is a second sequence diagram showing an example communication flow according to the fifth embodiment of the present invention;

FIG. 5 is a first sequence diagram showing an example communication flow according to a sixth embodiment of the present invention;

FIG. 6 is a second sequence diagram showing an example communication flow according to the sixth embodiment of the present invention;

FIG. 7 is a third sequence diagram showing an example communication flow according to the sixth embodiment of the present invention;

FIG. 8 is a diagram showing an example functional structure of a base station according to an embodiment of the present invention;

FIG. 9 is a diagram showing an example functional structure of a terminal according to an embodiment of the present invention;

FIG. 10 is a diagram showing an example hardware structure of base station or terminal according to an embodiment of the present invention; and

FIG. 11 is a diagram showing an example structure of a vehicle according to an embodiment of the present invention.

### DETAILED DESCRIPTION OF THE PREFERRED EMBODIMENTS

Now, embodiments of the present invention will be described below with reference to the accompanying drawings. Note that the embodiments described below are only examples, and the applicability of the present invention is by no means limited to the following embodiments.

Existing techniques may be used as appropriate to operate the wireless communication system according to the embodiments of the present invention. Examples of these existing techniques include, but are not limited to, existing NR or LTE. Also, unless otherwise specified, the term “LTE” as used herein has a broad meaning, covering LTE-Advanced and systems that emerged after LTE-Advanced (for example, NR).

Also, in the following description of embodiments of the present invention, terms that are used in existing LTE will be used, including “synchronization signal (SS),” “primary SS (PSS),” “secondary SS (SSS),” “physical broadcast channel (PBCH),” “physical random access channel (PRACH),” “physical downlink control channel (PDCCH),” “physical downlink shared channel (PDSCH),” “physical uplink control channel (PUCCH),” “physical uplink shared channel (PUSCH),” and so forth. This is for ease of description, and signals, functions, and so forth that are the same or substantially the same as these may be referred to by other names. Also, in NR, the above terms correspond to NR-SS, NR-PSS, NR-SSS, NR-PBCH, NR-PRACH, and so forth. However, signals used in NR may not be always written with the prefix “NR-.”

Also, according to the embodiments of the present invention, the duplex method may be time division duplex (TDD), frequency division duplex (FDD), or any other method (including, for example, flexible duplex).

Also, according to the embodiments of the present invention, when a radio parameter or the like is “configured,” this may mean that a predetermined value is configured in advance (or “pre-configured”), or mean that a radio parameter or the like that is reported from a base station or a terminal is configured.

### System Structure

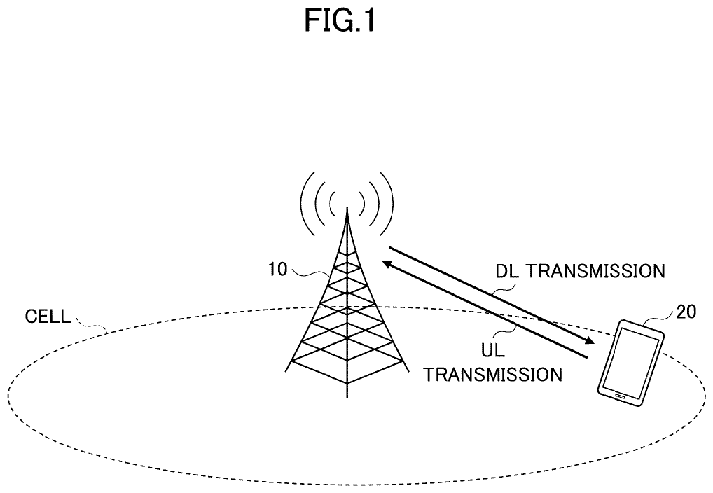

FIG. 1 is a diagram for explaining a wireless communication system according to an embodiment of the present invention. The wireless communication system according to an embodiment of the present invention includes a base station 10 and a terminal 20, as shown in FIG. 1. Although one base station 10 and one terminal 20 are shown in FIG. 1, this is just one example, and there may be two or more of each.

The base station 10 is a communication device that provides one or more cells and performs wireless communication with the terminal 20. Physical resources for radio signals are given in the time domain and the frequency domain. The time domain resources may be indicated by the number of orthogonal frequency division multiplexing (OFDM) symbols, and the frequency domain resources may be indicated by the number of subcarriers or resource blocks. Also, a transmission time interval (TTI) in the time domain may be a slot, or a TTI may be a subframe.

The base station 10 transmits synchronization signals and system information to the terminal 20. The synchronization signals include, for example, NR-PSS and NR-SSS. The system information is transmitted, for example, on NR-PBCH, and is also referred to as “broadcast information.” The synchronization signals and system information may be referred to as “SS/PBCH block” (SSB). Referring to FIG. 1, the base station 10 transmits controls signal or data to the terminal 20 via downlink (DL), and receives control signals or data from the terminal 20 via uplink (UL). Both the base station 10 and the terminal 20 can transmit and receive signals by using beamforming. Also, both the base station 10 and the terminal 20 can apply multiple-input multiple-output (MIMO) communication to DL or UL. Also, the base station 10 and the terminal 20 may both communicate via a secondary cell (SCell) and a primary cell (PCell) in carrier aggregation (CA). Furthermore, in the event dual connectivity (DC) is deployed, the terminal 20 may communicate via a primary cell of the base station 10 and a primary secondary cell group cell (PSCell: Primary SCG Cell) of another base station 10.

The terminal 20 is a communication device with a wireless communication function, such as a smartphone, a mobile phone, a tablet, a wearable terminal, or a machine-to-machine (M2M) communication module. As shown in FIG. 1, the terminal 20 receives control signals or data from the base station 10 via DL, and transmits control signals or data to the base station 10 via UL, thereby using various communication services provided by the wireless communication system. Also, the terminal 20 receives various reference signals transmitted from the base station 10 and measures the quality of propagation paths based on the result of receiving these reference signals. Note that the terminal 20 may be referred to as a “UE,” and the base station 10 may be referred to as a “gNB.”

Next, what discussions are taking place in NR Release 18 on power saving for base stations will be explained. Techniques for allowing base stations and terminals to improve their network energy saving performance are under study taking both transmission and reception at base stations into account. For example, a method for allowing a base station to achieve more efficient adaptation of dynamic and/or semi-static transmission and/or reception, at a finer granularity, using network energy saving techniques in one or more of the time, frequency, space, and power domains based on potential support/feedback, as well as potential assistance information, from the terminals, is under study.

### Problems with Related Art

Next, problems with related art will be described. One heretofore unaddressed issue is that how a terminal should behave to obtain information about base station energy saving functions is not specified. To be more specific, there are the following six problems.

The first problem is that how to distinguish between a cell that supports base station energy saving (NES: Network Energy Saving) (hereinafter also referred to as an “NES cell”) and a cell that does not support NES (hereinafter also referred to as a “normal cell”) is not specified. Furthermore, deploying an NES cell entails another problem that how to determine whether a terminal that does not support NES (hereinafter a “normal terminal,” whereas a terminal that supports NES will be hereinafter referred to as an “NES terminal”) is allowed to stay in (or “camp on”) the NES cell is not specified.

The second problem is that, when an NES cell goes “off” or is deactivated, the terminals in that cell must switch to other cells all at once. Therefore, although sending a notice to the terminals about the time period in which the NES cell is off/deactivated, the types of neighboring cells, the level of congestion, etc. would allow the terminals to switch to other cells in advance, how to send such a notice is not specified.

The third problem is that, when an NES cell is off/deactivated, the terminals in that cell must be switched to other cells. Nevertheless, the base station has no way of knowing what type of cell a given terminal wants to switch to next (whether the terminal wants to switch to an NES cell or a normal cell) or the characteristics (the SSB period, the DTX pattern, etc.) of the cell the terminal wants to switch to next.

The fourth problem is that, assuming that an NES terminal makes a handover or a conditional handover, what content needs to be exchanged between the source node and the target node is not specified.

The fifth problem is that what content needs to be exchanged between the master node (MN) and a secondary node (SN) in dual connectivity is not specified.

The sixth problem is that, although information about NES cells needs to be exchanged among multiple RAN nodes, what information needs to be exchanged is not specified.

### Overview of Embodiments

The following embodiments will be explained using examples in which a terminal obtains information about base station energy saving functions.

Below, the first embodiment to sixth embodiments will be explained as specific embodiments.

### First Embodiment

In this embodiment, an example for solving the above-mentioned first problem will be described.

When a terminal 20 is in an NES cell (the “serving cell” of the terminal 20), a command might be sent, using MIB or SIB1, to give an indication that the cell is an NES cell.

If the terminal 20 is in an NES cell, a command might be sent, using MIB or SIB1, to give an indication about whether or not a normal terminal is allowed to camp on that cell.

If the terminal 20 is in a normal cell, a command might be sent, using MIB or SIB1, to give an indication about whether or not an NES terminal is allowed to camp on that cell.

According to this embodiment, the terminal 20 can distinguish between an NES cell and a normal cell. Also, in the event an NES cell is deployed, whether or not a normal terminal is allowed to camp on that cell can be determined. Furthermore, in the event a normal cell is deployed, whether or not an NES terminal is allowed to camp on that cell can be determined.

### Second Embodiment

In this embodiment, an example for solving the above-mentioned second problem will be described.

The terminal 20 may assume that information that indicates the time period in which the cell is on/off (for example, a time window that shows whether the cell is activated/deactivated, a timer that shows the time until the cell is activated/deactivated, the time the cell's activation/deactivation starts/ends, etc.), or the cell's discontinuous transmission (DTX) pattern/periodicity, is sent in SIB.

The terminal 20 may also assume that the above information is sent by using L1/L2 signaling or RRC-dedicated signaling.

The terminal 20 may also assume that the above information is sent to group terminals by using L1/L2 multicast signaling or RRC multicast signaling.

The terminal 20 may assume that information that indicates a cell list including the types of neighboring cells (including, for example, information that distinguishes between NES cells and normal cells) is sent in SIB.

The terminal 20 may assume that information that indicates a cell list including the level of congestion per neighboring cell type (for example, information that is indicative of whether or not a given neighboring cell is congested) is sent in SIB.

The terminal 20 may assume that information that indicates a list of cells on which only NES terminals are allowed to camp is sent in SIB.

When the terminal 20 switches to another cell, terminal-dedicated signaling (that is, an RRC release with redirection or simply a “release with redirection”) may be used. The terminal 20 may assume that information that commands an RRC release with redirection is transmitted using RRC multicast signaling. That is, the terminal 20 may assume that the content of an RRC release (for example, carrier information to be redirected (RedirectedCarrierInfo)) is sent by multicast signaling and that the group terminals are redirected to other carriers/cells all at once.

Alternatively, the terminal 20 may assume that an RRC release with redirection is sent in SIB. That is, the terminal 20 may assume that the content of an RRC release (e.g., carrier information to be redirected (RedirectedCarrierInfo)) is sent in SIB and that the terminals in the cell are redirected to other carriers/cells all at once.

According to this embodiment, the terminal 20 can perform operations such as switching to other cells in advance based on information about the cells' on/off.

### Third Embodiment

In this embodiment, an example for solving the above-mentioned third problem will be described.

The terminal 20 may transmit, to the base station 10, a command that indicates whether the terminal 20 desires an NES cell or a normal cell in terminal assistance information (UEAssistanceInfo).

The terminal 20 may transmit, to the base station 10, the desired SSB period (i.e., SMTC: SSB-based measurement timing configuration), discontinuous transmission (DTX) period, DRX period, and frequency band (bandwidth: e.g. 20 MHz, 40 MHz, 80 MHz, 100 MHz, etc.) in the terminal assistance information.

According to this embodiment, the base station 10 can know the type of the cell (an NES cell or a normal cell) that the terminal 20 wants to switch to next, or the characteristics (the SSB period, the DTX pattern, etc.) of the cell that the terminal 20 wants to switch to next.

### Fourth Embodiment

In this embodiment, an example for solving the above-mentioned fourth problem will be described.

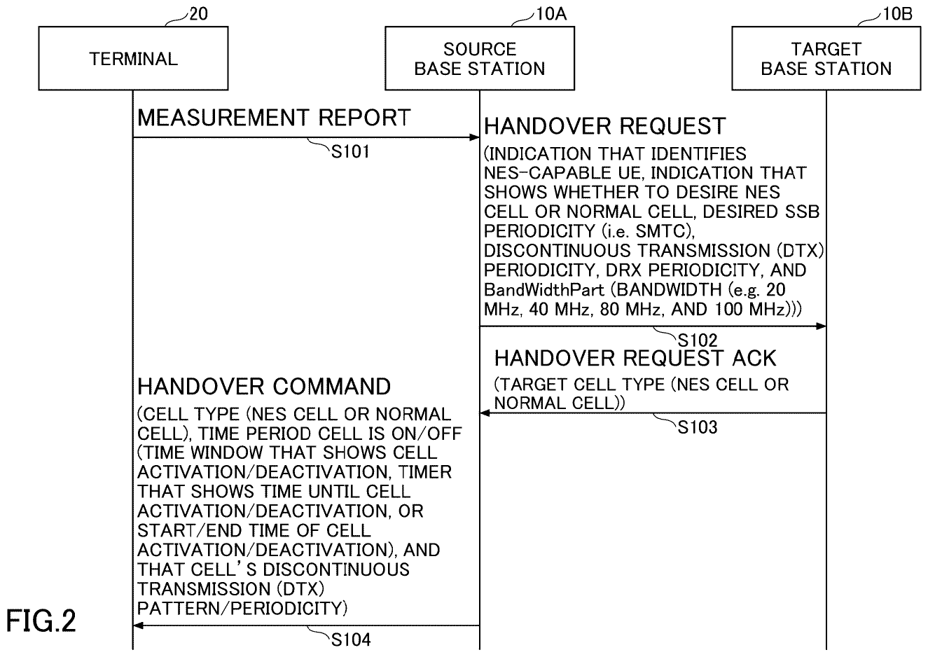

FIG. 2 is a sequence diagram showing an example communication flow according to a fourth embodiment of the present invention. In step S101, the terminal 20 transmits a measurement report to the source node (source base station 10A).

In step S102, the source node (source base station 10A) may include a command that indicates that the terminal 20 is an NES terminal, in a handover request, and transmit it to the target node (target base station 10B).

In step S102, the source node (source base station 10A) may include a command that indicates whether the terminal 20 desires an NES cell or a normal cell, in the handover request, and send it to the target node (target base station 10B).

In step S102, the source node (source base station 10A) may include information that indicates the SSB period (i.e. SMTC: SSB-based measurement timing configuration), discontinuous transmission (DTX) period, DRX period, and frequency band (bandwidth: e.g., 20 MHz, 40 MHz, 80 MHz, 100 MHz, etc.) that the terminal 20 desires, in the handover request, and send it to the target node (target base station 10B).

In step S103, the target node (target base station 10B) may include information that indicates the type of the target cell (an NES cell or a normal cell) in a response to the handover request and send it to the source node (source base station 10A).

In step S103, if the target node (target base station 10B) does not support NES terminals or does not support the SSB period (i.e., SMTC: SSB-based measurement timing configuration), discontinuous transmission (DTX) period, DRX period, or frequency band (bandwidth: e.g., 20 MHz, 40 MHz, 80 MHz, 100 MHz, etc.) that the terminal 20 desires, the target node (target base station 10B) may send a signal that indicates a handover preparation failure or a handover reject, to the source node (source base station 10A).

In step S104, the source node (source base station 10A) may transmit a handover command including its cell type (for example, an NES cell or a normal cell) to the terminal 20.

In step S104, the source node (source base station 10A) may transmit the handover command to the terminal 20 including information that indicates the time period in which the cell is on/off (for example, a time window that shows whether the cell is activated/deactivated, a timer that shows the time until the cell is activated/deactivated, the time the cell's activation/deactivation starts/ends, etc.), or the cell's discontinuous transmission (DTX) pattern/periodicity.

According to this embodiment, when an NES terminal performs a handover or a conditional handover, information can be exchanged between the source node and the target node.

### Fifth Embodiment

In this embodiment, an example for solving the fifth problem described above will be described.

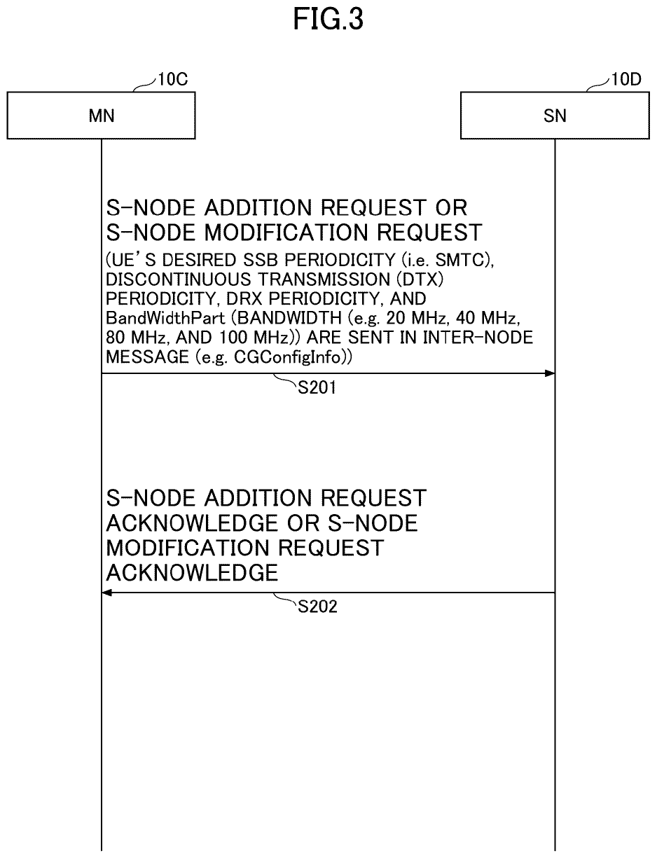

FIG. 3 is a first sequence diagram showing an example communication flow according to a fifth embodiment of the present invention.

In step S201, when setting up or making a change in dual connectivity, a master node (MN) 10C may include the SSB period (i.e., SMTC: SSB-based measurement timing configuration), discontinuous transmission (DTX) period, DRX period, and frequency band that the terminal 20 desires (bandwidth: e.g., 20 MHz, 40 MHz, 80 MHz, 100 MHz, etc.), in an inter-node message (e.g., CGConfigInfo), and transmit the message to a secondary node (SN) 10D.

The inter-node message may be an “S-NODE ADDITION REQUEST” or an “S-NODE MODIFICATION REQUEST.”

In step S202, the SN 10D may transmit an “S-NODE ADDITION REQUEST ACKNOWLEDGE” or an “S-NODE MODIFICATION REQUEST ACKNOWLEDGE” to the MN 10C.

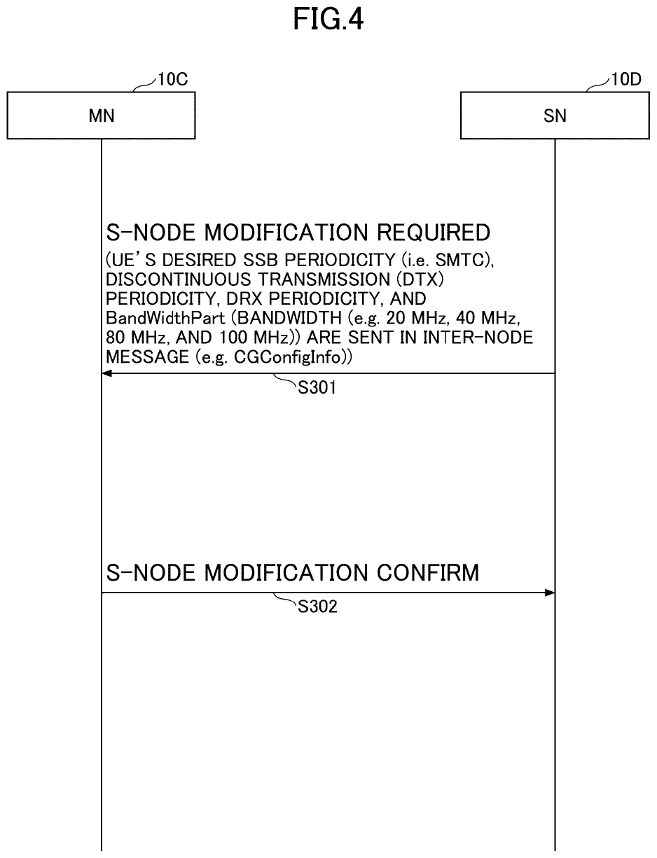

FIG. 4 is a second sequence diagram showing an example communication flow according to the fifth embodiment of the present invention.

In step S301, when setting up or making a change in dual connectivity, the SN 10D may include the SSB period (i.e., SMTC: SSB-based measurement timing configuration), discontinuous transmission (DTX) period, DRX period, and frequency band that the terminal 20 desires (bandwidth: e.g., 20 MHz, 40 MHz, 80 MHz, 100 MHz, etc.), in an inter-node message (e.g., CGConfigInfo), and transmit the message to the MN 10C.

The inter-node message m be an “S-NODE MODIFICATION REQUIRED.”

In step S302, MN 10C may transmit an “S-NODE MODIFICATION CONFIRM” to the SN 10D.

According to this embodiment, information can be exchanged between the master node (MN) and a secondary node (SN) in dual connectivity.

### Sixth Embodiment

In this embodiment, an example for solving the sixth problem mentioned above will be described.

A RAN node may transmit information that indicates an NES cell's ID, the time period in which the NES cell is on/off (for example, a time window that shows whether the NES cell is activated/deactivated, a timer that shows the time until the NES cell is activated/deactivated, or the time the NES cell's activation/deactivation starts/ends, etc.), the NES cell's discontinuous transmission (DTX) pattern/periodicity, etc., to other RAN nodes, via an Xn interface.

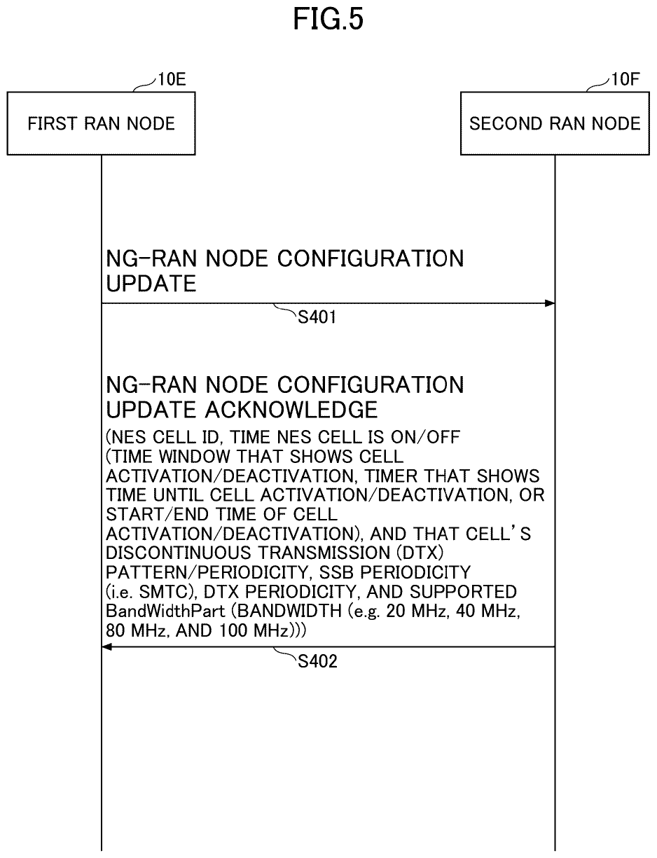

FIG. 5 is a first sequence diagram showing an example communication flow according to a sixth embodiment of the present invention.

In step S401, a first RAN node 10E transmits an “NG-RAN NODE CONFIGURATION UPDATE” to a second RAN node 10F.

In step S402, the second RAN node 10F transmits an “NG-RAN NODE CONFIGURATION UPDATE ACKNOWLEDGE” to the first RAN node 10E, including information that indicates an NES cell's ID, the time period in which the NES cell is on/off (for example, a time window that shows whether the NES cell is activated/deactivated, a timer that shows the time until the NES cell is activated/deactivated, the time the NES cell's activation/deactivation starts/ends, etc.), the NES cell's discontinuous transmission (DTX) pattern/periodicity, etc.

Also, information that indicates an NES cell's ID, the time period in which the NES cell is on/off (for example, a time window that shows whether the NES cell is activated/deactivated, a timer that shows the time until the NES cell is activated/deactivated, the time the NES cell's activation/deactivation starts/ends, etc.), the NES cell's discontinuous transmission (DTX) pattern/periodicity, etc., may be exchanged between a centralized unit (CU) and a distributed unit (DU) via an F1 interface.

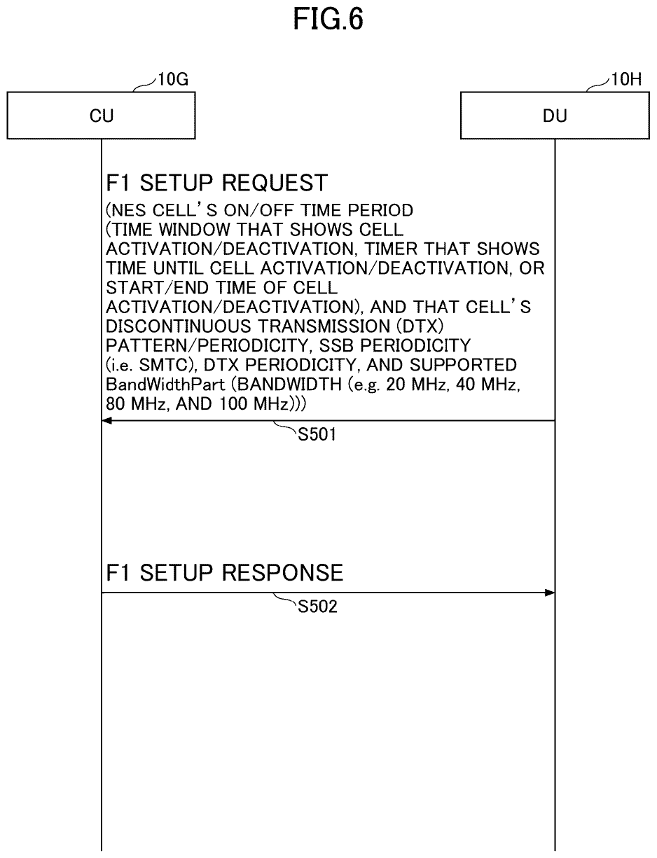

FIG. 6 is a second sequence diagram showing an example communication flow according to the sixth embodiment of the present invention.

In step S501, a DU 10H transmits an “F1 SETUP REQUEST” to a CU 10G, including information that indicates an NES cell's ID, the time period in which the NES cell is on/off (for example, a time window that shows whether the NES cell is activated/deactivated, a timer that shows the time until the NES cell is activated/deactivated, the time the NES cell's activation/deactivation starts/ends, etc.), the NES cell's discontinuous transmission (DTX) pattern/periodicity, etc.

In step S502, the CU 10G transmits an “F1 SETUP RESPONSE” to the DU 10H.

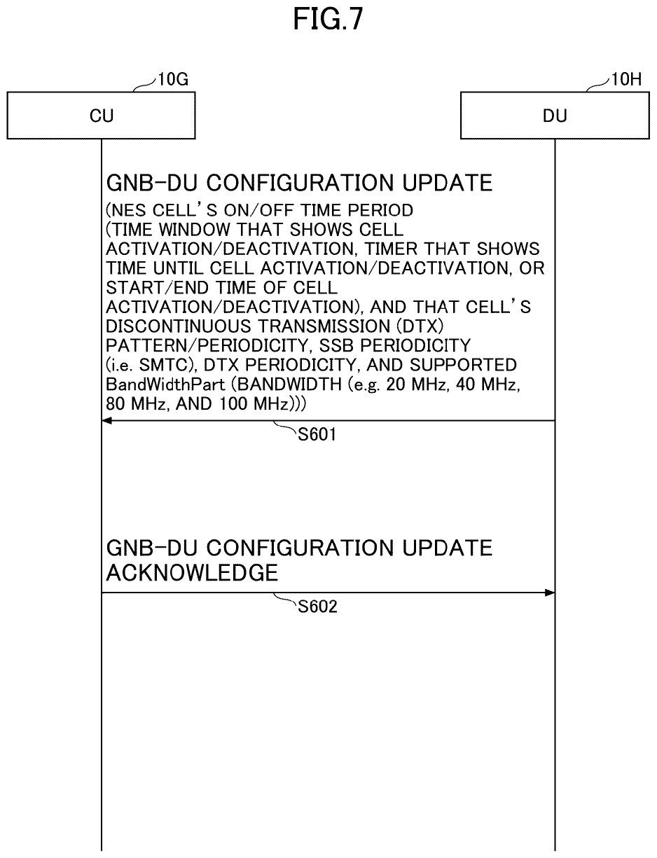

FIG. 7 is a third sequence diagram showing an example communication flow according to the sixth embodiment of the present invention.

In step S601, the DU 10H transmits a “GNB-DU CONFIGURATION UPDATE” to the CU 10G, including information that indicates an NES cell's ID, the time period in which the NES cell is on/off (for example, a time window that shows whether the NES cell is activated/deactivated, a timer that shows the time until the NES cell is activated/deactivated, or the time the NES cell's activation/deactivation starts/ends, etc.), the NES cell's discontinuous transmission (DTX) pattern/periodicity, etc.

In step S602, the CU 10G transmits a “GNB-DU CONFIGURATION UPDATE ACKNOWLEDGE” to the DU 10H.

According to this embodiment, information about NES cells can be exchanged among multiple RAN nodes.

The embodiments described above thus make clear the method of identifying NES cells when an NES function is introduced, the method of allowing a terminal located in a cell to switch to another cell when no NES cell is on, what information about NES needs to be exchanged between the source node and the target node upon a handover, and so forth. These embodiments are expected to contribute to NES.

### Device Structure

Next, example functional structures of the base station 10 and the terminal 20 that perform the processes and operations described above will be described. The base station 10, the terminal 20, and various network nodes have functions to implement the embodiments described above. However, the base station 10, the terminal 20, and various network nodes may each have only part of the functions of the embodiments described above.

### Base Station 10 and Network Nodes

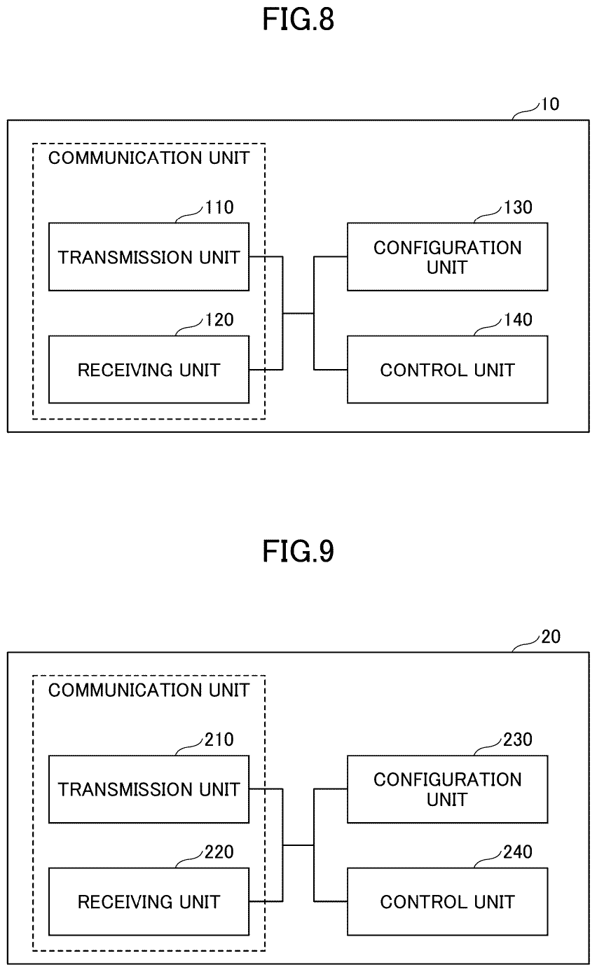

FIG. 8 is a diagram that illustrates an example functional structure of the base station 10. As illustrated in FIG. 8, the base station 10 includes a transmitting unit 110, a receiving unit 120, a configuration unit 130, and a control unit 140. The functional structure illustrated in FIG. 8 is only one example. As long as the operations according to the embodiments of the present invention can be implemented, any functional categories and any functional unit names may be used. Note that a network node may have a functional structure that is similar to that of the base station 10. Also, a network node having multiple different functions in the system architecture may be composed of multiple network nodes separated by function.

The transmitting unit 110 has, for example, a function to generate signals to be transmitted to the terminal 20 or other network nodes and transmit the signals via a wireless or wired connection. The receiving unit 120 has, for example, a function to receive various signals transmitted from the terminal 20 and acquire, for example, higher layer information from the received signals.

The configuration unit 130 stores preset configuration information and various pieces of configuration information to be transmitted to the terminal 20 in a storage device, and reads the information from the storage device when necessary. The content of the configuration information includes, for example, configurations related to communications using NTN.

The control unit 140 performs processes related to communications using NTN, as described in the embodiments. The control unit 140 also performs processes related to communications with the terminal 20. The control unit 140 also performs a process related to confirmation of the geographical position of the terminal 20. A functional unit related to signal transmission in the control unit 140 may be included in the transmitting unit 110, and a functional unit related to signal reception in the control unit 140 may be included in the receiving unit 120.

### Terminal 20

FIG. 9 is a diagram showing an example functional structure of the terminal 20. As shown in FIG. 9, the terminal 20 has a transmitting unit 210, a receiving unit 220, a configuration unit 230, and a control unit 240. The functional structure shown in FIG. 9 is simply an example. As long as the operations according to the embodiments of the present invention can be implemented, any functional categories and any functional unit names may be used. The USIM attached to the terminal 20 may have a transmitting unit 210, a receiving unit 220, a configuration unit 230, and a control unit 240, as in the terminal 20.

The transmitting unit 210 creates a transmitting signal from transmitting data and transmits the transmitting signal via wireless connection. The receiving unit 220 receives various signals via a wireless connection and obtains higher layer signals from the physical layer signals received. The receiving unit 220 also has a function to receive NR-PSS, NR-SSS, NR-PBCH, DL/UL control signals, reference signals, and so on, that are transmitted from the network nodes.

The configuration unit 230 stores various configuration information received from the network nodes by the receiving unit 220 in a storage device and reads it from the storage device when necessary. The configuration unit 230 also stores configuration information that is configured in advance.

The terminal or the base station in the above embodiments may be structured or configured as follows. Furthermore, the following communication method may be implemented.

### Structures and Configurations According to Embodiments

### First Example

A terminal including: a receiving unit configured to receive system information via downlink; and a control unit configured to assume that information that indicates whether or not a serving cell is a cell supporting a base station energy saving function is included in the system information.

### Second Example

The terminal of the first example, in which the control unit is configured to assume that information about an on period or an off period of a cell or cells that neighbor the serving cell is reported.

### Third Example

The terminal of the first or the second example, further including a transmitting unit configured to transmit, via uplink, a command that indicates whether or not the cell supporting the base station energy saving function is desired.

### Fourth Example

A base station including: a receiving unit configured to receive information that indicates a handover request from a terminal supporting a base station energy saving function; and a transmitting unit configured to transmit, to another base station that serves as a handover destination, a command that indicates that the terminal is a terminal supporting the base station energy saving function.

### Fifth Example

The base station of the fourth example, in which the transmitting unit is configured to transmit information about a cell that supports the base station energy saving function to a master node or a secondary node in dual connectivity, another RAN node, or another base station that functions as a CU or a DU.

### Sixth Example

A communication method to be executed by a terminal, including: a step of receiving system information via downlink; and a step of assuming that information that indicates whether or not a serving cell is a cell supporting a base station energy saving function is included in the system information.

Any of the above structures and configurations provides a technique for enabling transmission and reception of information related to base station energy saving functions. The first example above allows it to assume that information that is indicative of whether or not the serving cell supports base station energy saving functions is included and reported in system information. The second example above allows it to assume that information about in what time period(s) the neighboring cell or cells are activated or deactivated is reported to the serving cell. According to the third example above, a command that indicates whether or not to desire a cell that supports base station energy saving functions can be transmitted via uplink. According to the fourth example, a command that indicates that the terminal supports base station energy saving functions can be transmitted to another base station that serves as a handover destination. According to the fifth example, information about a cell that supports base station energy saving functions can be transmitted to the master node or a secondary node in dual connectivity, another RAN node, or another base station that functions as a CU or a DU.

### Hardware Structure

The block diagrams (FIG. 8 and FIG. 9) used in the description of the above embodiments illustrate blocks of functional units. These functional blocks (components) are implemented by any combination of hardware and/or software. In addition, the method of implementing each functional block is not particularly limited. That is, each functional block may be implemented by using a single device that is physically or logically combined, or two or more devices that are physically or logically separated may be directly or indirectly connected (for example, by using a cable, radio, etc.), and each functional block may be implemented using these multiple devices. The functional blocks may be implemented by combining software with the device or devices.

The functions include, but are not limited to, judgment, determination, decision, calculation, computation, processing, derivation, research, search, verification, reception, transmission, output, access, resolution, selection, choosing, establishment, comparison, assumption, assumption, deeming, broadcasting, notifying, communicating, forwarding, configuring, reconfiguring, allocating, mapping, and assigning. For example, a functional block (component) that performs a transmission function is referred to as a “transmitting unit” or a “transmitter.” In either case, as described above, the method of implementation is not particularly limited.

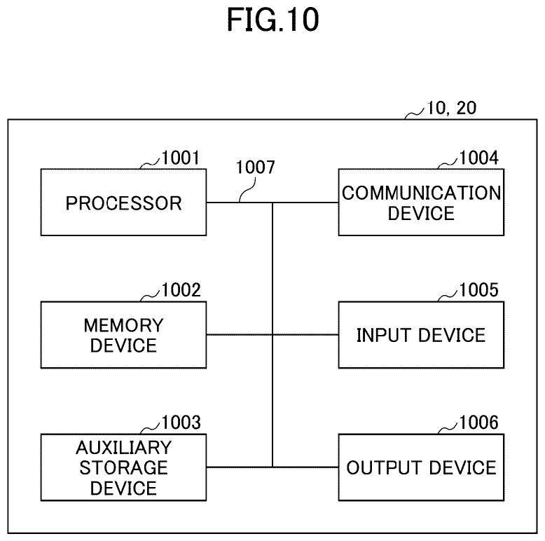

For example, the network nodes, the terminal 20, and so forth according to the embodiments of the present disclosure may function as a computer for processing the wireless communication method of the present disclosure. FIG. 10 is a diagram that illustrates an example hardware structure of the base station 10 and the terminal 20 according to the embodiments of the present disclosure. The network nodes may be structured the same or substantially the same as the base station 10. The USIM may be structured the same or substantially the same as the terminal 20. The base station 10 and the terminal 20 described above may be physically configured as a computer device including a processor 1001, a storage device 1002, an auxiliary storage device 1003, a communication device 1004, an input device 1005, an output device 1006, a bus 1007, and the like.

In the following description, the term “device” can be read as circuit, apparatus, unit, and so forth. The hardware structure of the base station 10 and the terminal 20 may be configured to include one or more of the devices illustrated in the drawings, or may be configured without some of the devices.

The functions of the base station 10 and the terminal 20 are realized by performing operations by the processor 1001 by reading predetermined software (programs) on hardware such as the processor 1001 and the storage device 1002, and controlling communication by the communication device 1004 and controlling at least one of reading and writing of data in the storage device 1002 and the auxiliary storage device 1003.

The processor 1001 operates, for example, an operating system to control the entire computer. The processor 1001 may be composed of a central processing unit (CPU) including an interface with peripheral devices, a control device, an arithmetic device, a register, and the like. For example, the above-described control unit 140, control unit 240, and the like may be implemented by the processor 1001.

The processor 1001 reads out programs (program codes), software modules, data, or the like from at least one of the auxiliary storage device 1003 and the communication device 1004 to the storage device 1002, and performs various processes in accordance with the above. As for the programs, programs that cause the computer to execute at least part of the operations described in the above embodiments may be used. For example, the control unit 140 of the base station 10 illustrated in FIG. 8 may be stored in the storage device 1002 and implemented by control programs that operate on the processor 1001. For example, the control unit 240 of the terminal 20 illustrated in FIG. 9 may be stored in the storage device 1002 and implemented by control programs that operate on the processor 1001. Although the foregoing processes have been described and executed by one processor 1001, they may be executed simultaneously or sequentially by two or more processors 1001. The processor 1001 may be implemented by one or more chips. The programs may be transmitted from the network via a telecommunication line.

The storage device 1002 is a computer-readable recording medium and may be composed of at least one of, for example, a read-only memory (ROM), an erasable programmable ROM (EPROM), an electrically erasable programmable ROM (EEPROM), a random access memory (RAM), and the like. The storage device 1002 may be referred to as a register, cache, main memory (main storage device), or the like. The storage device 1002 can store programs (program codes), software modules, and so forth, executable to implement the communication method according to the embodiments of the present disclosure.

The auxiliary storage device 1003 is a computer-readable recording medium and may be composed of at least one of an optical disk, such as a compact disc ROM (CD-ROM), a hard disk drive, a flexible disk, a magneto-optical disk (for example, a compact disc, a digital versatile disc, a Blu-ray disc (registered trademark), etc.), a smart card, a flash memory (for example, a card, a stick, a key drive), a floppy disk (registered trademark), a magnetic strip, and the like. The storage medium described above may be, for example, a database, a server, or other suitable medium that includes at least one of a storage device 1002 and an auxiliary storage device 1003.

The communication device 1004 is hardware (a transceiving device) for performing communication between computers via at least one of a wired network and a wireless network, and is also referred to as a “network device,” a “network controller,” a “network card,” a “communication module,” or the like. The communication device 1004 may be composed of a high frequency switch, a duplexer, a filter, a frequency synthesizer, or the like, for example, to implement at least one of frequency division duplex (FDD) and time division duplex (TDD). For example, the transmitting/receiving antenna, the amplifier unit, the transceiving unit, the transmission line interface, and the like may be implemented by the communication device 1004. The transceiving unit may be physically or logically isolated, respective implementations of a transmitting unit and a receiving unit.

The input device 1005 is an input device (for example, a keyboard, a mouse, a microphone, a switch, a button, a sensor, etc.) that accepts external input. The output device 1006 is an output device (for example, a display, a speaker, an LED lamp, etc.) that implements external output. The input device 1005 and the output device 1006 may have an integral structure (for example, a touch panel).

Each device, such as the processor 1001 and the storage device 1002, is connected by a bus 1007 for communicating information. The bus 1007 may be constructed using a single bus or may be constructed using different buses between devices.

The base station 10 and the terminal 20 may also include hardware such as a microprocessor, a digital signal processor (DSP), an application-specific integrated circuit (ASIC), a programmable logic device (PLD), a field programmable gate array (FPGA), and so forth, and some or all of the functional blocks may be implemented by the hardware. For example, the processor 1001 may be implemented by using at least one of these hardware components.

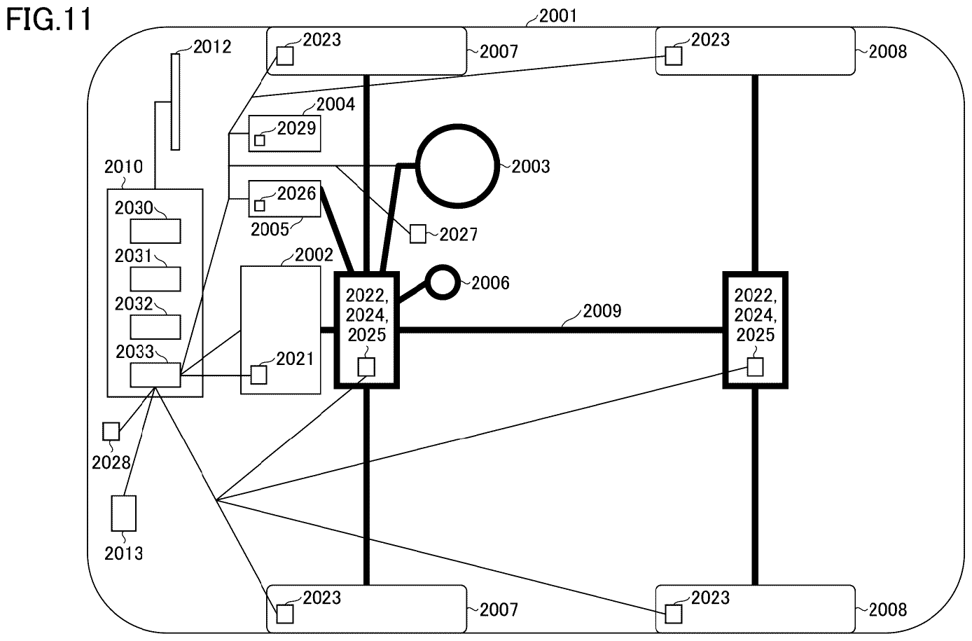

FIG. 11 shows an example structure of a vehicle 2001. As shown in FIG. 11, the vehicle 2001 includes a drive unit 2002, a steering unit 2003, an accelerator pedal 2004, a brake pedal 2005, a shift lever 2006, a front wheel 2007, a rear wheel 2008, an axle 2009, an electronic control unit 2010, various sensors 2021 to 2029, an information service unit 2012, and a communication module 2013. The embodiments and examples described in the present disclosure may be applied to a communication device mounted in the vehicle 2001, and may be applied to, for example, the communication module 2013.

The drive unit 2002 may include, for example, an engine, a motor, and a hybrid of an engine and a motor. The steering unit 2003 includes at least a steering wheel and is configured to steer at least one of the front wheel and the rear wheel, based on the operation of the steering wheel operated by the user.

The electronic control unit 2010 includes a microprocessor 2031, a memory (ROM, RAM) 2032, and a communication port (IO port) 2033. The electronic control unit 2010 receives signals from the sensors 2021 to 2029 provided in the vehicle 2001. The electronic control unit 2010 may be referred to as an “electronic control unit” (ECU).

The signals from the sensors 2021 to 2029 include a current signal from a current sensor 2021 that senses the current of the motor, a front or rear wheel rotation speed signal acquired by a rotation speed sensor 2022, a front or rear wheel air pressure signal acquired by an air pressure sensor 2023, a vehicle speed signal acquired by a vehicle speed sensor 2024, an acceleration signal acquired by an acceleration sensor 2025, a stepped-on accelerator pedal signal acquired by an accelerator pedal sensor 2029, a stepped-on brake pedal signal acquired by a brake pedal sensor 2026, a shift lever operation signal acquired by a shift lever sensor 2027, and a detection signal, acquired by an object detection sensor 2028, for detecting an obstacle, a vehicle, a pedestrian, and the like.

The information service unit 2012 includes various devices for providing various information such as driving information, traffic information, and entertainment information, including a car navigation system, an audio system, a speaker, a television, and a radio, and one or more ECUs that control these devices. The information service unit 2012 provides various multimedia information and multimedia services to the occupants of the vehicle 2001 by using information obtained from external devices through the communication module 2013 or the like.

The information service unit 2012 may include an input device (for example, a keyboard, a mouse, a microphone, a switch, a button, a sensor, a touch panel, etc.) that accepts external inputs, and may also include an output device (for example, a display, a speaker, an LED lamp, a touch panel, etc.) that executes external outputs.

A driver assistance system unit 2030 includes: various devices for providing functions of preventing accidents and reducing the driver's burden of driving, such as a millimeter wave radar, a light detection and ranging (LIDAR) system, a camera, a positioning locator (for example, GNSS), map information (for example, high definition (HD) map, autonomous vehicle (AV) map, etc. ), a gyro system (for example, an inertial measurement unit (IMU), an inertial navigation system (INS), etc.), an artificial intelligence (AI) chip, and an AI processor; and one or more ECUs that control these devices. In addition, the driver assistance system unit 2030 transmits and receives various information via the communication module 2013 to implement a driver assistance function or an autonomous driving function.

The communication module 2013 may communicate with the microprocessor 2031 and components of the vehicle 2001 via a communication port. For example, the communication module 2013 transmits and receives data via a communication port 2033, to and from the drive unit 2002, the steering unit 2003, the accelerator pedal 2004, the brake pedal 2005, the shift lever 2006, the front wheel 2007, the rear wheel 2008, the axle 2009, the microprocessor 2031, the memory (ROM, RAM) 2032 in the electronic control unit 2010, and the sensors 2021 to 29 provided in the vehicle 2001.

The communication module 2013 is a communication device that can be controlled by the microprocessor 2031 of the electronic control unit 2010 and that is capable of communicating with external devices. For example, various kinds of information are transmitted to and received from external devices through wireless communication. The communication module 2013 may be internal or external to the electronic control unit 2010. The external devices may include, for example, a base station, a mobile station, or the like.

The communication module 2013 may transmit at least one of: signals input to the electronic control unit 2010 from the sensors 2021 to 2029; information obtained based on these signals; and information based on inputs from the outside (user) obtained via the information service unit 2012, to external devices via wireless communication. The electronic control unit 2010, the sensors 2021 to 2029, the information service unit 2012, and the like may be referred to as an “input unit” that accepts inputs. For example, PUSCH transmitted by the communication module 2013 may include information that is based on an input such as one described above.

The communication module 2013 receives various information (traffic information, signal information, inter-vehicle distance information, etc.) transmitted from external devices and displays these pieces of information an information service unit 2012 provided in the vehicle 2001. The information service unit 2012 may also be referred to as an “output unit” that outputs information (or that, for example, outputs information to devices such as a display or a speaker based on PDSCH (or data/information decoded from PDSCH) received by the communication module 2013).

In addition, the communication module 2013 stores the information received from the external devices in the memory 2032, to which the microprocessor 2031 has access. Based on the information stored in the memory 2032, the microprocessor 2031 may control the drive unit 2002, the steering unit 2003, the accelerator pedal 2004, the brake pedal 2005, the shift lever 2006, the front wheel 2007, the rear wheel 2008, the axle 2009, the sensors 2021 to 2029, and so forth, mounted in the vehicle 2001.

### Notes on Embodiments

Example embodiments of the present invention have been described above, but the disclosed invention is not limited to the above embodiments, and those skilled in the art would understand that there may be various modified examples, revised examples, alternative examples, substitution examples, and the like. In order to facilitate understanding of the invention, specific numerical values have been used for description, but the numerical values are merely examples, and any suitable values may be used unless otherwise specified. The classification of items in the above description is not essential to the present invention. Matters described as two or more items may be combined if necessary, and a matter described as one item may be applied to another item (as long as there is no contradiction). The boundary between functional units or processing units in a functional block diagram does not necessarily correspond to the boundary between physical parts. Operations of multiple functional units may be performed physically by one component, or an operation of one functional unit may be physically performed by multiple parts. In the processing procedures described in the embodiments, the order of the processes may be changed as long as there is no contradiction. For the sake of convenience of processing description, the base station 10 and the terminal 20 are described using functional block diagrams, but such devices may be implemented by hardware, software, or a combination of these. Software executed by the processor included in the base station 10 according to the embodiments of the present invention and software executed by the processor included in the terminal 20 according to the embodiments of the present invention may be stored in a random access memory (RAM), a flash memory, a read-only memory (ROM), an EPROM, an EEPROM, a register, an hard disk drive (HDD), a removable disk, a CD-ROM, a database, a server, or any other appropriate storage medium.

Furthermore, notification of information is not limited to the embodiments or examples described in the present disclosure, and may be provided by using any other method. For example, the notification of information may be provided by physical layer signaling (for example, downlink control information (DCI) or uplink control information (UCI)), higher layer signaling (for example, radio resource control (RRC) signaling, medium access control (MAC) signaling, broadcast information (master information block (MIB), system information block (SIB), etc.), other signals, or a combination thereof. Furthermore, RRC signaling may be referred to as an “RRC message” and may be, for example, an RRC connection setup message, an RRC connection reconfiguration message, or the like.

Each embodiment and example described in the present disclosure may be applied to at least one of long-term evolution (LTE), LTE-advanced (LTE-A), SUPER 3G, IMT-Advanced, 4th generation mobile communication system (4G), 5th generation mobile communication system (5G), 6th generation mobile communication system (6G), x-th generation mobile communication system (xG) (where “x” is an integer, decimal, etc.), future radio access (FRA), new radio (NR), new radio access (NX), future generation radio access, W-CDMA (registered trademark), GSM (registered trademark), CDMA 2000, ultra mobile broadband (UMB), IEEE 802.11 (Wi-Fi (registered trademark)), IEEE 802.16 (WiMAX (registered trademark)), IEEE 802.20, ultra-wideband (UWB), Bluetooth (registered trademark), a system using any other appropriate system, and next generation systems enhanced, modified, created, and defined based on these standards. Furthermore, multiple systems (for example, a combination of at least one of LTE and LTE-A, with 5G) may be combined to be applied.

The order of the processing procedures, the order of the sequences, the order of the flowcharts, and the like of the respective embodiments and examples described in this specification may be changed, provided that there is no contradiction. For example, the method described in the present disclosure presents elements of various steps with an example order and is not limited to the presented, specific order.

In this specification, a specific operation to be performed by the base station 10 may be performed by its upper node in some cases. In a network including one or more network nodes including the base station 10, various operations performed for communication with the terminal 20 can be obviously performed by at least one of the base station 10 and any network node (for example, an MME, an S-GW, and so forth, but these are by no means limiting) other than the base station 10. Cases have been shown above in which there is one network node other than the base station 10. The one network node may be a combination of multiple other network nodes (for example, MME and S-GW).

Information, a signal, or the like described in the present disclosure may be output from a higher layer to a lower layer (or from a lower layer to a higher layer). Information, a signal, or the like described in the present disclosure may be input and output via multiple network nodes.

Input and output information and the like may be stored in a specific place (for example, a memory), or may be managed by using a management table. Input and output information and the like may be overwritten, updated, or additionally written. Output information and the like may be deleted. Input information and the like may be transmitted to other devices.

The determination in the present disclosure may be made in accordance with a value (0 or 1) represented by one bit, may be made in accordance with a Boolean value (Boolean: true or false), or may be made by a comparison of numerical values (for example, a comparison with a predetermined value).

Software should be broadly interpreted to mean a command, a command set, a code, a code segment, a program code, a program, a subprogram, a software module, an application, a software application, a software package, a routine, a subroutine, an object, an executable file, an execution thread, a procedure, a function, and the like, regardless of whether software is called “software,” “firmware,” “middleware,” a “microcode,” a “hardware description language,” or any other name.

Furthermore, software, commands, information, and the like may be transmitted and received via a transmission medium. For example, when software is transmitted from a web site, a server, or any other remote source using a wired technology (such as a coaxial cable, a fiber optic cable, a twisted pair, or a digital subscriber line (DSL)) and a radio technology (such as infrared rays or a microwave), at least one of these wired technology and radio technology is included in a definition of a transmission medium.

Information, signals, and the like described in the present disclosure may be expressed using any one of a variety of techniques. For example, data, instructions, commands, information, signals, bits, symbols, chips, and the like, which are mentioned throughout the above description, may be expressed by voltages, currents, electromagnetic waves, magnetic fields or magnetic particles, optical fields or photons, or any combination thereof.

The terms described in the present disclosure and the terms necessary for understanding the present disclosure may be replaced with terms having the same or similar meanings. For example, at least one of a channel and a symbol may be a signal (signaling). Furthermore, a signal may be a message. Furthermore, a component carrier (CC) may be referred to as a “carrier frequency,” a “cell,” a “frequency carrier,” or the like.

The terms “system” and “network” used in the present disclosure are interchangeable.

Furthermore, the information, parameters, and the like described in the present disclosure may be expressed by using absolute values, may be expressed by using relative values from predetermined values, or may be expressed by using any other corresponding information. For example, radio resources may be indicated by indices.

The names used for the above-described parameters are not limited names in any point of view. Furthermore, mathematical formulas or the like using the parameters may be different from those explicitly disclosed in the present disclosure. Since various channels (for example, PUCCH, PDCCH, etc.) and information elements can be identified by any suitable names, various names assigned to the various channels and the information elements are not limited names in any point of view.

In the present disclosure, the terms “base station (BS),” “radio base station,” “fixed station,” “NodeB,” “eNodeB (eNB),” “gNodeB (gNB),” “access point,” “transmission point,” “reception point,” “transmission/reception point,” “cell,” “sector,” “cell group,” “carrier,” “component carrier,” and the like can be used interchangeably. The base station may also be referred to by a term such as a “macrocell,” a “small cell,” a “femtocell,” and a “picocell.”

The base station can accommodate one or more (for example, three) cells. In a case in which the base station accommodates multiple cells, the entire coverage area of the base station can be partitioned into a plurality of small areas, and each small area can provide a communication service through a base station subsystem (for example, a small indoor base station (RRH: Remote Radio Head)). The term “cell” or “sector” refers to the whole or a part of the coverage area of at least one of the base station and the base station subsystem that performs a communication service in the coverage.

In the present disclosure, when a base station transmits information to a terminal, this may be interpreted as meaning that the base station controls or sends a command to the terminal based on the information.

In the present disclosure, the terms “mobile station (MS),” “user terminal,” “user equipment (UE),” “terminal,” and the like can be used interchangeably.

The mobile station may be referred to, by a person ordinarily skilled in the art, as a “subscriber station,” a “mobile unit,” a “subscriber unit,” a “wireless unit,” a “remote unit,” a “mobile device,” a “wireless device,” a “wireless communication device,” a “remote device,” a “mobile subscriber station,” an “access terminal,” a “mobile terminal,” a “wireless terminal,” a “remote terminal,” a “handset,” a “user agent,” a “mobile client,” a “client,” or some other suitable terms.

At least one of the base station and the mobile station may be also referred to as a “transmission device,” a “receiving device,” a “communication device,” or the like. At least one of the base station and the mobile station may be a device installed in a mobile body, a mobile body itself, or the like. The moving object is a movable object with any moving speed, and naturally a case where the moving object is stopped is also included. Examples of the moving object include a vehicle, a transport vehicle, an automobile, a motorcycle, a bicycle, a connected car, a loading shovel, a bulldozer, a wheel loader, a dump truck, a fork lift, a train, a bus, a trolley, a rickshaw, a ship and other watercraft, an airplane, a rocket, a satellite, a drone, a multicopter, a quadcopter, a balloon, and an object mounted on any of these, but these are not restrictive. The moving object may be a moving object that autonomously travels based on a direction for moving. The moving object may be a vehicle (for example, a car, an airplane, and the like), may be a moving object which moves unmanned (for example, a drone, an automatic operation car, and the like), or may be a robot (a manned type or unmanned type). Note that at least one of a base station and a mobile station also includes an apparatus which does not necessarily move during communication operation. For example, at least one of a base station and a mobile station may be an Internet of Things (IoT) device such as a sensor.

Furthermore, the base station in the present disclosure may be replaced by the user terminal. For example, various embodiments and examples of the present disclosure may be applied to a configuration in which communication between the base station and the user terminal is replaced by communication between multiple terminals 20 (such communication may be referred to as “device-to-device (D2D)” communication, “vehicle-to-everything (V2X) ” communication, etc.). In this case, the terminals 20 may have and perform the functions that the base station 10 described above has. The phrases “uplink” and “downlink” may also be replaced by phrases corresponding to terminal-to-terminal communication (for example, “side”). For example, an uplink channel, a downlink channel, or the like may be replaced by a side channel.

Similarly, the user terminal in the present disclosure may be replaced with the base station. In this case, the base station may have the functions of the above-described user terminal.

The terms “determination (determining)” and “decision (determining)” used in the present specification may include various types of operations. The “determination” and “decision” may include deeming “judging,” “calculating,” “computing,” “processing,” “deriving,” “investigating,” “looking up (for example, searching in a table, a database, or another data structure),” “searching,” “inquiring,” or “ascertaining” as “determining” and/or “deciding.” Furthermore, the “determination” and “decision” may include deeming “receiving (for example, receiving information),” “transmitting (for example, transmitting information),” “inputting,” “outputting,” or “accessing (for example, accessing data in a memory)” as “determining” and/or “deciding.” Furthermore, the “determination” and “decision” may include deeming “resolving,” “selecting,” “choosing,” “establishing,” or “comparing” as “determining” and/or “deciding.” Namely, the “determination” and “decision” may include deeming an operation as “determining” and/or “deciding.” Furthermore, “determining” may be replaced with “assuming,” “expecting,” “considering,” or the like.

The terms “connected,” “coupled,” or variations thereof may mean any direct or indirect connection or coupling between two or more elements and may include the presence of one or more intermediate elements between two elements which are “connected” or “coupled.” The coupling or the connection between the elements may be physical, logical, or a combination thereof. For example, “connection” may be replaced with “access.” In the present disclosure, two elements may be considered to be “connected” or “coupled” with each other using at least one of one or more electric wires, cables and/or a printed electrical connection or using electromagnetic energy having a wavelength in a radio frequency region, a microwave region, or a light (both visible and non-visible) region as non-limiting and non-exhaustive examples.

A reference signal may be abbreviated as “RS” and may be referred to as a “pilot,” depending on the standard that is applied.

The phrase “based on” used in the present disclosure does not only mean “based only on,” unless otherwise stated. In other words, the phrase “based on” means both “based only on” and “based at least on.”

Reference to elements with designations such as “first,” “second,” and so on as used in the present disclosure does not generally limit the quantity or order of these elements. These designations may be used in the present disclosure only for convenience, as a method for distinguishing between two or more elements. Thus, reference to the first and second elements does not imply that only two elements may be employed, or that the first element must precede the second element in some way.

Furthermore, “means” in the structure of each of the above devices may be replaced with “unit,” “part,” “circuit,” “device,” or the like.

In the case where the terms “include,” “including” and variations thereof are used in the present disclosure, these terms are intended to be comprehensive in the same way as the term “comprising.” Further, the term “or” used in the present specification is not intended to be an “exclusive or.”

A radio frame may include one or more frames in the time domain. In the time domain, each of one or more frames may be referred to as a “subframe.” The subframe may further include one or more slots in the time domain. The subframe may have a fixed time length (for example, 1 ms) not depending on numerology.

Numerology may be a communication parameter applied to at least one of transmission and reception of a certain signal or channel. For example, numerology may indicate at least one of subcarrier spacing (SCS), the bandwidth, the symbol length, the cyclic prefix length, the transmission time interval (TTI), the number of symbols per TTI, the radio frame structure, a specific filtering process performed in the frequency domain by a transceiver, a specific windowing process performed in the time domain by a transceiver, and the like.

A slot may include one or more symbols (orthogonal frequency division multiplexing (OFDM) symbols, single carrier frequency division multiple access (SC-FDMA) symbols, etc. ) in the time domain. A slot may be a time unit based on numerology.

A slot may include a plurality of mini slots. Each mini slot may include one or more symbols in the time domain. Furthermore, a mini slot may be referred to as a “sub-slot.” A mini slot may include fewer symbols than a slot. PDSCH (or PUSCH) that is transmitted in a unit of time greater than a mini slot may be referred to as “PDSCH (or PUSCH) mapping type A.” PDSCH (or PUSCH) that is transmitted using a mini slot may be referred to as “PDSCH (or PUSCH) mapping type B.”

Any one of a radio frame, a subframe, a slot, a mini slot, and a symbol indicates a time unit for transmitting a signal. As a radio frame, a subframe, a slot, a mini slot, a symbol, different names corresponding to them may be used.

For example, one subframe may be referred to as a “transmission time interval (TTI),” or a plurality of consecutive subframes may be referred to as a “TTI,” or one slot or one mini slot may be referred to as a “TTI.” In other words, at least one of the subframe and the TTI may be a subframe (1 ms) in conventional LTE, may be a period shorter than 1 ms (for example, 1 to 13 symbols), or may be a period longer than 1 ms. A unit representing the TTI may be referred to a “slot,” a “mini slot,” or the like, instead of a “subframe.”

Here, for example, the TTI refers to a minimum time unit of scheduling in wireless communication. For example, in an LTE system, the base station performs scheduling of allocating radio resources (frequency bandwidth, transmission power, or the like which can be used in each terminal 20) to each terminal 20 in units of TTIs. The definition of the TTI is not limited thereto.

The TTI may be a transmission time unit such as a channel-coded data packet (transport block), a code block, or a codeword, or may be a processing unit of, for example, scheduling or link adaptation. Furthermore, when a TTI is provided, the time interval (for example, the number of symbols) in which a transport block, a code block, a codeword, or the like is actually mapped may be shorter than the TTI.

When one slot or one mini slot is referred to as a “TTI,” one or more TTIs (that is, one or more slots or one or more mini slots) may be a minimum time unit of scheduling. Furthermore, the number of slots (the number of mini slots) forming the minimum time unit of scheduling may be controlled.

A TTI having a time length of 1 ms may be referred to as a “common TTI” (TTI in LTE Rel. 8 to 12), a “normal TTI,” a “long TTI,” a “common subframe,” a “normal subframe,” a “long subframe,” a “slot,” or the like. A TTI shorter than a common TTI may be referred to as a “reduced TTI,” a “short TTI,” a “partial TTI” (a partial or fractional TTI), a “reduced subframe,” a “short subframe,” a “mini slot,” a “sub slot,” a “slot,” or the like.

Furthermore, a long TTI (for example, a normal TTI, a subframe, etc.) may be replaced with a TTI having a time length exceeding 1 ms, and a short TTI (for example, a reduced TTI or the like) may be replaced with a TTI having a TTI length that is shorter than a TTI length of a long TTI and that is longer than or equal to 1 ms.

The resource block (RB) is a resource allocation unit in the time domain and the frequency domain, and may include one or more consecutive subcarriers in the frequency domain. The number of subcarriers included in an RB may be the same, irrespective of the numerology and may be, for example, 12. The number of subcarriers included in an RB may be determined based on numerology.

An RB may include one or a plurality of symbols in the time domain, and may be one slot, one mini-slot, one subframe, or one TTI in length. One TTI, one subframe, and so on each may be constituted of one or a plurality of resource blocks.

Furthermore, one or more RBs may be referred to as a “physical resource block (PRB,” a “subcarrier group (SCG),” a “resource element group (REG),” a “PRB pair,” an “RB pair,” or the like.

Furthermore, a resource block may be formed with one or more resource elements (REs). For example, one RE may be a radio resource field of one subcarrier and one symbol.

A bandwidth part (BWP) (which may be referred to as a “partial bandwidth” or the like) may indicate a subset of consecutive common resource blocks (RBs) for a certain numerology in a certain carrier. Here, a common RB may be specified by an index of an RB based on a common reference point of a carrier. A PRB may be defined in a BWP and numbered in a BWP.

The BWP may include BWP for UL (UL BWP) and BWP for DL (DL BWP). In the terminal 20, one or more BWPs may be configured in one carrier.

At least one of configured BWPs may be active, and the terminal 20 need not assume that predetermined signals/channels are transmitted and received outside an active BWP. Furthermore, a “cell,” a “carrier,” or the like in the present disclosure may be replaced with a “BWP.”

Structures of the radio frame, the subframe, the slot, the mini slot, and the symbol are merely examples. For example, configurations such as the number of subframes included in a radio frame, the number of slots per subframe or radio frame, the number of mini slots included in a slot, the number of symbols and RBs included in a slot or a mini slot, the number of subcarriers included in an RB, the number of symbols in a TTI, the symbol length, the cyclic prefix (CP) length, and the like can be variously changed.

In the present disclosure, for example, when an article such as “a,” “an,” or “the” in English is added by a translation, the present disclosure may include a case in which a noun following the article is the plural.

In the present disclosure, “A and B are different” may mean “A and B are different from each other.” However, this may also mean “A and B are different from C.” Terms such as “separated” or “combined” may be interpreted as well as “different.”

Each embodiment or example described in the present disclosure may be used alone, in combination, or may be switched in accordance with the implementation. Furthermore, notification of predetermined information (for example, notification of “being X”) is not limited to notification performed explicitly, but may be performed implicitly (for example, not notifying the predetermined information).

Although the present disclosure has been described above in detail, it is obvious to those skilled in the art that the present disclosure is not limited to the embodiments described in the present disclosure. The present disclosure may be implemented as revised and modified embodiments without departing from the gist and scope of the present disclosure as set forth in the accompanying claims. Accordingly, the description of the present disclosure is for the purpose of illustration and does not have any restrictive meaning to the present disclosure.

This application claims priority based on Japanese Patent Application No. 2022-165611, filed on Oct. 14, 2022, the entire contents of which are incorporated herein by reference.

### DESCRIPTION OF THE REFERENCE NUMERALS

10 base station
10A Source base station
10B target base station
10C MN
10D SN
10E first RAN node
10F second RAN node
10G CU
10H DU
110 transmitting unit
120 receiving unit
130 configuration unit
140 control unit
20 terminal
210 transmitting unit
220 receiving unit
230 configuration unit
240 control unit
1001 processor
1002 storage device
1003 auxiliary storage device
1004 communication device
1005 input device
1006 output device
2001 vehicle
2002 drive unit
2003 steering unit
2004 accelerator pedal
2005 brake pedal
2006 shift lever
2007 front wheel
2008 rear wheel
2009 axle
2010 electronic control unit
2012 information service unit
2013 communication module
2021 current sensor
2022 rotation speed sensor
2023 air pressure sensor
2024 vehicle speed sensor
2025 acceleration sensor
2026 brake pedal sensor
2027 shift lever sensor
2028 object detection sensor
2029 accelerator pedal sensor
2030 driver assistance system unit
2031 microprocessor
2032 memory (ROM, RAM)
2033 communication port (IO port)

1. A terminal comprising:
a receiving unit configured to receive system information via downlink; and
a control unit configured to assume that information that indicates whether or not a serving cell is a cell supporting a base station energy saving function is included in the system information.

2. The terminal according to claim 1, wherein the control unit is configured to assume that information about an on period or an off period of a cell or cells that neighbor the serving cell is reported.

3. The terminal according to claim 1, further comprising a transmitting unit configured to transmit, via uplink, a command that indicates whether or not the cell supporting the base station energy saving function is desired.

4. A base station comprising:
a receiving unit configured to receive information that indicates a handover request from a terminal supporting a base station energy saving function; and
a transmitting unit configured to transmit, to another base station that serves as a handover destination, a command that indicates that the terminal is a terminal supporting the base station energy saving function.

5. The base station according to claim 4, wherein the transmitting unit is configured to transmit information about a cell that supports the base station energy saving function to a master node or a secondary node in dual connectivity, another RAN node, or another base station that functions as a CU or a DU.

6. A communication method to be executed by a terminal, comprising:
a step of receiving system information via downlink; and
a step of assuming that information that indicates whether or not a serving cell is a cell supporting a base station energy saving function is included in the system information.
